(19) United States
(12) Patent Application Publication
(10) Pub. No.: US 2007/0038409 A1
(43) Pub. Date: Feb. 15, 2007

(54) Position sensing means and method

(76) Inventors: Kurt Gilson, Redwood City, CA (US); Kevin David McGushion, Simi Valley, CA (US)

Correspondence Address: AARON PAUL MCGUSHION, 127 6TH ST., # 4, SEAL BEACH, CA, 90740, US

(21) Appl. No.: 11/195,326

(22) Filed: Aug. 2, 2005

(51) Int. Cl. G01B 21/00

(52) U.S. Cl. 702/150

(57) ABSTRACT

A position sensing device to locate a point in three-dimensional space relative to an origin is provided. The invention generally is comprised of a housing, a rigid extension with a fixed terminus protruding from the housing, a position sensing means fixed to the housing, a logic circuit responsive to the position sensing means, and a processor responsive to the logic circuit. The logic circuit and processor may be located externally from the housing. Wherein the fixed terminus can be collocated with an origin and thereafter collocated with a point in space away from the origin, the vector formed between the two points being accurately measured by the position sensing device.

### BACKGROUND

1. Field of Invention

This invention relates generally to a position sensing system and method for use thereof, and, more particularly, to a device that is able to accurately locate and point to the position of a point, in three-dimensional space, in relation to a specified origin or series of origins in the construction of a facility.

2. Description of Prior Art

When constructing manufacturing facilities for industries such as biotechnology, pharmaceutical, semiconductor, petrochemical, and power generation, a system of fluid conditioning and transportation components are installed throughout a building, between a series of buildings, or other type of structure. These pipes, valves, vessels, and similar flow components are interconnected, transporting fluids to specified locations inside and outside of the building or structure. The position of these various components relative to one another is critical, with an allowable tolerance of only a fraction of an inch over a distance of many yards. This level of accuracy must be maintained while remaining within strict budget and time constraints. Accurate and rapid measurement is a strict requirement for safe, rapid and cost effective industrial construction.

To meet both budgetary and time limitations, as much of the fluid flow system as possible is prefabricated. Accuracy must be tightly controlled while fabricating the fluid flow systems off-site. Highly accurate, prefabricated flow assemblies, consisting of numerous flow components, can easily be installed in the facility, interconnecting without the need for excessive adjustment or field fitting. Additionally, the placement of these prefabricated flow assemblies within the facility must be tightly controlled. Numerous prefabricated flow assemblies and various flow components are brought to the facility under construction, and are assembled within the facility, each assembly forming a piece of a complex fluid flow system. If either the accuracy of the assembly's construction or the accuracy of the assembly's placement is compromised, then field fitting will likely be necessary to realign the assemblies to insure a leak-tight relationship. Field fitting can cause delays in the construction schedule and cost many man-hours.

The process of fitting and realignment of assemblies and various flow components is extremely expensive, but necessary with the current construction methods. The manufacture of semiconductor chips or the refining of petroleum, for example, requires the use of many gases and liquids, many of them being volatile or deadly poisonous. There is a near zero tolerance for leakage of these volatile substances. Additionally, due to the ultra high purity requirements of many industries, it is absolutely necessary to prevent impurities from entering the fluid system. Therefore, a near perfect seal is needed between the numerous connections of the fluid flow system.

The placement of these flow components and assemblies are made increasingly more difficult when constructing a semiconductor manufacturing facility. The primary external structure is a large open building, forming an outer shell. Inside this shell, many clean rooms and partitions are created to house the different processes. The installation of the various rooms and internal structures create a complex maze of walls, rooms, and various other structures. No clean line of sight is possible, often being obstructed almost immediately within a matter of feet. Accurate measurement across large spaces in the building is a continuing problem.

It is after the inner rooms have been created that the prefabricated flow assemblies and flow components can be installed. Various parts of the fluid flow system lead to and from these rooms, and can be an intricate part of each room. As a result, it is necessary to install the majority of the fluid flow system after the inner rooms are completed. This, however, creates a situation where it is difficult to measure the exact location of one assembly relative to another assembly, with the line of sight being blocked by various structures. Even when line of sight measurement is possible, the current methods, such as photogrammetry, do not produce measurements that meet accuracy, cost and time limitations.

It would seem, at first glance, that the walls and features of the building and inner structures would make an acceptable point of reference for which to locate the flow components and assemblies. Yet, the structure of the building itself has a tolerance for error that is far larger than the tolerance for error of the network of gas and fluid pipes, fixtures, and vessels being installed within the building. In fact, the allowed deviation from the original design of the building may be on the order of a few inches, while the flow components and assemblies within the building generally must be positioned within a small fraction of an inch from the designed position. The angles and planes of the building's walls are equally inaccurate. Additionally, the completed structure of the building often deviates from the planned building drawn in the construction documents. Therefore, the building itself cannot be used as a reliable datum for the positioning of the gas fixtures contained within it.

A datum or series of datums must be established within or relatively near the building, but not relying exclusively on the location of the building's structure. From this datum, all measurements and locations of the fluid flow system are originated. Only in this way can the exact relative position of the various flow components can be guaranteed, insuring substantially exact mating and sealing between corresponding flow components.

The current method of installing the fluid flow system involves measuring distances from a datum with tape measures and other measuring devices of similar accuracy, often approximating the three-dimensional position of a flow component. These measurements need to be carried through the walls and structures of the inner rooms, often passing through several structures before connecting the origination point to the termination point. There is often a stacking of errors, as one measurement is taken off the preceding measurement. Due to this, the termination point of the measurement can be offset an unacceptable distance from required location. To reduce this error, measurements are taken many times over to recheck the location, wasting many thousands of man-hours.

After a path has been measured between the origination point to the termination point, holes are cut through walls and the inner structure is modified to allow the passage of pipes. After the holes are cut and the components are fitted, it is often the case with current methods that there is a misalignment. The immediate sections of the flow system often must be disassembled, the holes in the walls repaired, and the fluid flow assemblies cut and refitted in the field to compensate for measurement errors.

The average construction costs of a semiconductor manufacturing facility can easily be in the hundreds of millions in US dollars. Accuracy as well as timeliness are critical factors. As mentioned previously, the positioning of the fluid flow assemblies are controlled to a high degree, and the accuracy required is of high importance. However, the length of time required to construct the facility is also critical. Semiconductor facilities are planned in advance of a predicted microchip demand, with the planned completion coinciding with the demand. Any delays in the completion can cost the manufacturer many millions of dollars each day in lost revenues. Therefore, this industry and many others, require a system of measurement that is accurate and can be quickly implemented.

The implementation of an accurate measurement system that can be applied to the construction of semiconductor facilities could save millions of dollars in construction costs and reduce the overall time required for construction. This not only saves money, it also enables the facility to earn money for the parent company at an earlier date, increasing overall profit over the life of the facility.

Several methods for solving this measurement problem have been considered. For instance, a global positioning system (GPS) is a possibility. The primary problem with using global positioning technology is that the global positioning devices currently available to industry are not accurate enough to position the gas fixtures within a small fraction of an inch of the designed position, in a two-dimensional plane. Additionally, the signals used for GPS location are often not powerful enough to penetrate the ceiling and walls of the facility. For these preceding two reasons, a global positioning device would not likely be appropriate for the positioning of the gas lines and fixtures.

Another possible solution might be attempted using a radio positioning device. Two datum radio devices may be placed in stationary positions in or near the building in which the flow components or assemblies are to be installed. A portable radio positioning device, being on the same frequency as the datum radio devices (to allow for radio triangulation), can be moved throughout the building until the signal indicates that the portable radio positioning device is a predetermined distance away from both of the datum radio devices; this said position should be at or near the designed location of the flow component.

The limitations of a radio positioning device can be understood more clearly if the layout and design of a semiconductor manufacturing facility is also understood. As described previously, inside the manufacturing facility there are numerous clean rooms for the assembly and manufacture of various semiconductor products, such as microchips. These completely enclosed rooms have relatively thick walls, usually with no windows. The thick walled nature of these clean rooms may possibly prevent the effective transmission of radio waves; especially when there are several clean-rooms between the datum radio device and the portable radio positioning device. Because the accuracy of the radio waves is related to the frequency, shorter wavelengths having the greatest accuracy, a high frequency signal is required to meet the accuracy demands. However, high frequency waves cannot easily penetrate the concrete and steel walls, thus eliminating this as a viable measurement option.

What is needed is a device that can accurately locate the position of a point, in three-dimensional space, in relation to a stationary datum point or series of datum points. This device should have the capability to directly point to a position designated by a design plan within a stated tolerance. What is also needed is a position sensing device that can operate accurately in a situation where communication with the datum point may not be possible due to obstructions or other forms of interference. Additionally, what is needed, is a position sensing device that enables a method of component installation that does not require multiple fittings, and allows for complete prefabrication of flow assemblies, saving both time and money.

### SUMMARY OF THE INVENTION

In accordance with the present invention, a position sensing device to locate a point in three-dimensional space relative to an origin is provided. The invention generally is comprised of a housing, a rigid extension with a fixed terminus protruding from the housing, a position sensing means fixed to the housing, a logic circuit responsive to the position sensing means, and a processor responsive to the logic circuit. The logic circuit and processor may be located externally from the housing. Wherein the fixed terminus can be collocated with an origin and thereafter collocated with a point in space away from the origin, the vector formed between the two points being accurately measured by the position sensing device.

In a preferred embodiment, the invention generally is comprised of a housing, a rigid extension with a fixed terminus protruding from the housing, at least one solid state three axis accelerometer, a logic circuit responsive to the solid state three axis accelerometers for yielding a non-gravitational acceleration along each input axis, and a processor responsive to the logic circuit.

In a second preferred embodiment, there are two, three axis accelerometers fixed a known distance from one another; or alternatively, three or more one axis accelerometers can be used. Upon processing, the accelerometer sensor data is conditioned to ascertain the location and attitude of the fixed terminus relative to an origin. A display means generates a graphical or alphanumerical image of the location in cartesian or vector coordinate format (x, y, z or radius, theta). A data storage means may be employed to record the path data for later use, or to store preset location points.

Additionally, the position data stored may be exported to a CAD program for use in generating a three dimensional map of the components within a facility or other series of positions measured. The raw data would likely be a series of coordinates relative to a set origin. This series of coordinates can be translated within the CAD software; and an image of the recorded points can be superimposed over the existing construction document file or separately manipulated. Drawing blocks of the components can be positioned with the construction document file, giving an accurate representative location of each component relative to the building design.

Although preferred, it is not necessary for the display, processor, and storage means to be located within the housing for each embodiment. It is possible for the position sensing device to be in data communication with an external computing means, such as a computer system, laptop, PDA, or other similar device. The case can be physically attached to the external computing means or be in wireless communication.

An additional embodiment may include a filtering means. When an accelerometer is transported a distance, electronic noise may give rise to a degree of error. This noise is not related to the path; and should not be included in the calculation of the position vector. A filtering means may be utilized to eliminate this noise.

Protruding from the housing is a rigid extension of predetermined length, generally with a diminishing tip at the terminus converging to a point, called the position pointer. The position pointer is a fixed distance and known relative location from the accelerometers. The rigid extension with the position pointer at the terminus should be constructed in such a manner so that it may be used to point to an exact position designated by a design plan, or assigned by some other manner, with the capability for a user to place the position point on a designated location point or datum.

The acceleration, in any direction, sensed by the solid state three axis accelerometers, can be used to mathematically derive a position. The relative values of acceleration sensed by the solid state three axis accelerometers are used to interpolate the location of the position pointer, in relation to the datum. The acceleration data collected from each solid state three axis accelerometer can be compared to derive a rotational relationship between the two. From this data, both the location of the position pointer and the tilt of the rigid extension can be calculated.

Therefore, a position in space can be pointed to without regard to the tilt angle of the case and locator extension. For example, if the designated component position is above the head of the operator, the rigid extension may be tilted upwards; and if the designated component position is below the waist of the operator, the rigid extension may be tilted downwards.

In a possible operational scenario, for example during the construction of a semiconductor manufacturing facility, the position sensing device is first placed at a known stationary datum for calibration purposes. Then, an origin, relative to the position pointer, is assigned at the datum and recorded in the data storage means.

When the position sensing device is removed from the datum location, it calculates and tracks the location of the position pointer relative to the datum throughout the entire path of travel. Because, in this situation, all of the dimensions in the design plan for the gas supply system are taken from the datum point, to find the location of a particular component, an operator carrying the position sensing device, needs only to travel away from the datum until the desired design point is reached by the position pointer.

When this desired design point is reached by the position pointer, the position sensing device displays a confirmation of the position, possibly in x, y, z coordinates. It is an option to preprogram the designed component positions into the position sensing device. In an embodiment of the invention, as the operator approaches a preprogrammed point, the position sensing device will signal to the operator the proximity of the unit to the targeted position, possibly through the display or through an audible signal.

In an alternate embodiment of the present invention, at least one solid state three axis gyro is used in conjunction with at least one solid state three axis accelerometer. The solid state three axis gyro is fixed in the housing with at least one solid state three axis accelerometer. The path of travel is tracked by the solid state three axis accelerometer, while the tilt and rotation of the position sensing device is tracked by the solid state three axis gyro. A logic circuit or series of circuits responsive to the solid state three axis accelerometer and the solid state three axis gyro is additionally present. The data from both sensors can be combined to present an accurate location of the position point relative to the datum point.

While the user is carrying the position sensing device through the building, designating each designed component position point, the operational behavior of the user should be considered. For instance, if the user should drop the position sensing device while in transit between two points or if the user were to carry the position sensing device in a rough manner, the accelerometer installed may be exposed to an acceleration that causes the accelerometer to operate in a range of reduced accuracy. In the situation where the position sensing device is dropped, the accelerometer would experience an instantaneous acceleration that might exceed its ability to measure it accurately. Or, if the unit were to be carried in a rough manner, the accelerometer could operate for extended periods outside the ideal band of acceleration measurement, where accuracy is at its highest.

In an alternate embodiment, a series of accuracy meter interfaces are included. For each given model of accelerometer, the degree to which the sensor is able to measure distance, derived from acceleration, is considered. For low ranges of acceleration, the accelerometer may have the highest distance measurement accuracy. For higher ranges of acceleration, the accelerometer may have the least distance measurement accuracy.

An upper limit of the acceleration range is chosen to define the area in which the accelerometer is operating at its highest accuracy. Beyond that limit, the accuracy is reduced. Several other secondary limits may be chosen, indicating the areas of further reduced accuracy. Alternatively, a formula may be derived to correlate the given acceleration with an incremental degree of accuracy. Each level of accuracy corresponds to a percentage error measurement over a given distance. It is most desirable to remain within the acceleration range of highest accuracy.

One meter visible to the user correlates to the instantaneous measure of acceleration, called the instantaneous condition meter. One possible interface is a series of colored bars or lights. If the operator is within the highest range of accuracy, the bars will remain green (or any representative color). As the operator approaches and exceeds the first limit, the green bars will transition to yellow, indicating to the operator that the usage behavior should be altered. If the unit is dropped or likewise handled roughly, the bars will transition to red, indicating that the accuracy for that instance is not within the acceptable limits. All throughout the path of the unit, the operator will be informed of the instantaneous accuracy of the unit.

A second meter is used to represent the cumulative inaccuracy of the unit, as it progresses through a path, called the cumulative condition meter. As the operator exposes the unit to repeated levels of acceleration approaching or exceeding the assigned limit, then the meter will, again in a likewise tri-color bar fashion, indicate the level of inaccuracy. If the operator handles the unit with care, the meter will remain in the green. As the operator jostles the unit, the green bars will progressively stack, representing the accumulation of error, until reaching the yellow area. At this point, the operator may decide to recalibrate the unit by zeroing it at the datum, or continue with greater care. If the operator continues to roughly handle the position sensing device, the bars will progressively stack to the red area. This would indicate that the position sensing device can no longer guarantee the needed accuracy, and that is necessary to immediately recalibrate the unit at the datum.

The visual interface of the cumulative condition meter may be related to the numerical level of uncertainty. Under the best usage conditions, when the meter will be at the lower levels of green, the uncertainty may be approximately 0.125″. As the position sensing device is disturbed, the cumulative condition meter may progress to the yellow barred area. The yellow bars may correlate with a numerical uncertainty of approximately 0.25″. Finally, when the bars progress into the red, the uncertainty may be greater than 0.5″. The operator can judge, based on the expected accuracy of a measurement, if the measurement should proceed, or if the position sensing device should be recalibrated. The actual numerical uncertainty and its correlation to the status of the cumulative condition meter may vary according to the accuracy of the position sensing means installed in the position sensing device and the accuracy demands of each particular fabrication.

It is possible, for both meters, to have an audible alarm connected with the readout of the meters. Through the meters and alarm, curative actions are encourage on the part of the operator to correct and prevent further actions that could degrade the accuracy of the unit's measurement.

There are times when the exact pinpoint location of a designated position cannot be directly pointed to by the position sensing device. For instance, when the designated point lies within an inaccessible, enclosed structure or object, such as a pipe or other component. In an embodiment of the present invention, the circumference or outer perimeter of the object can be traced. This can be achieved by placing the terminus of the rigid extension on the surface of the object and closely tracking the outer geometry of the object. The position sensing device may have a control in which the operator designates the initiation point and completion point of the trace. As the object is being traced, the general shape of the object is being computed; and, upon completion of the trace, the center of geometry is calculated and designated as a point. One of the most common trace shapes will be circular, following the circumference of a pipe. This measurement can be critical when a component needs to be located and installed in-line or at the end of a pipe.

The present invention provides a device and method for locating a point in space with respect to a stationary datum. The present invention additionally provides a means to accurately locate a point in a complex facility where communication with the datum point may not be possible due to obstructions or other forms of interference.

### BRIEF DESCRIPTION OF THE DRAWINGS

FIG. 1A-B are perspective views of the present invention.

FIG. 2 is a cutaway view of the present invention, showing the interior components.

FIG. 3 is a perspective view of the present invention in data communication with an external computing device.

FIG. 4 is a cutaway view of an alternate embodiment of the present invention, showing the interior components.

FIG. 5 is a plan view of the present invention, showing a potential user interface layout.

FIG. 6 is a perspective view showing the present invention in transit from the datum to a position away from the datum.

### DESCRIPTION OF THE PREFERRED EMBODIMENTS

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

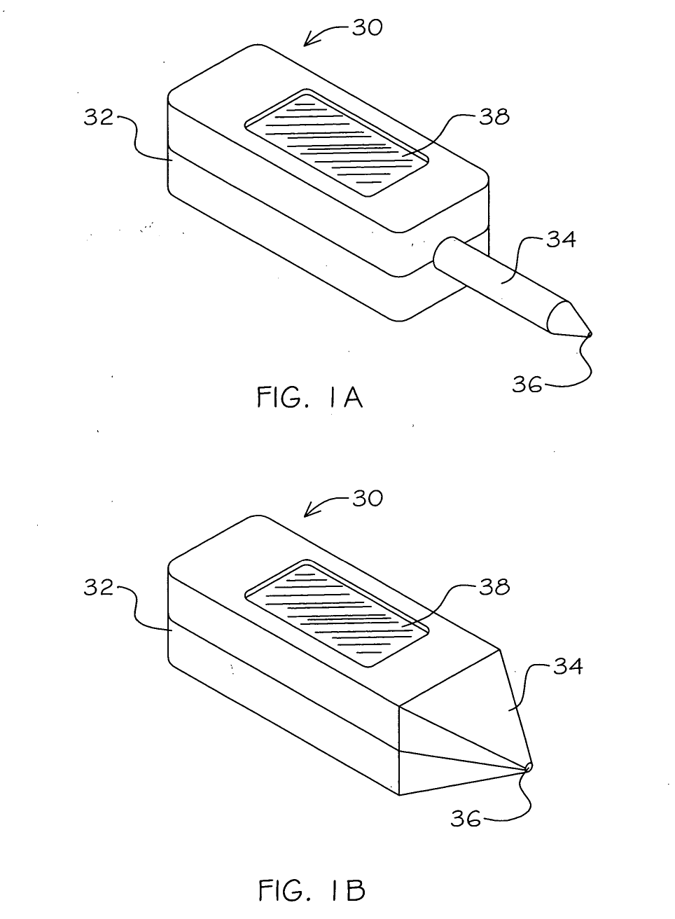

The position sensing device (30) of the present invention in two of many configurations can be seen in FIGS. 1A and 1B. In FIG. 1A, the position sensing device (30) is seen with a rigid extension (34) protruding normally from the housing (32). It is at the terminus of the rigid extension (34), that the position pointer (36) is located. Location and usage data is displayed continuously on the display (38). The display (38) can be any viewing medium, including LCD, LED, or similar component. Looking more closely at FIG. 1B, it can be seen that the rigid extension (34) can be created by simply transitioning the housing (32) geometry to the position pointer (36), the housing (32) converging to the position pointer (36).

Any number of housing styles can be used to achieve a pointing device. The primary purpose of the rigid extension (34) and the position pointer (36) is to accurately point to a datum to obtain a zero position, and successively point to a position in a space, the relative location of the position being calculated against the datum. As long as the function of the position pointer (36) is not obstructed and the rigid extension (34) is substantially fixed in relation to the housing (32), the exterior design of the rigid extension (34) is not of critical importance.

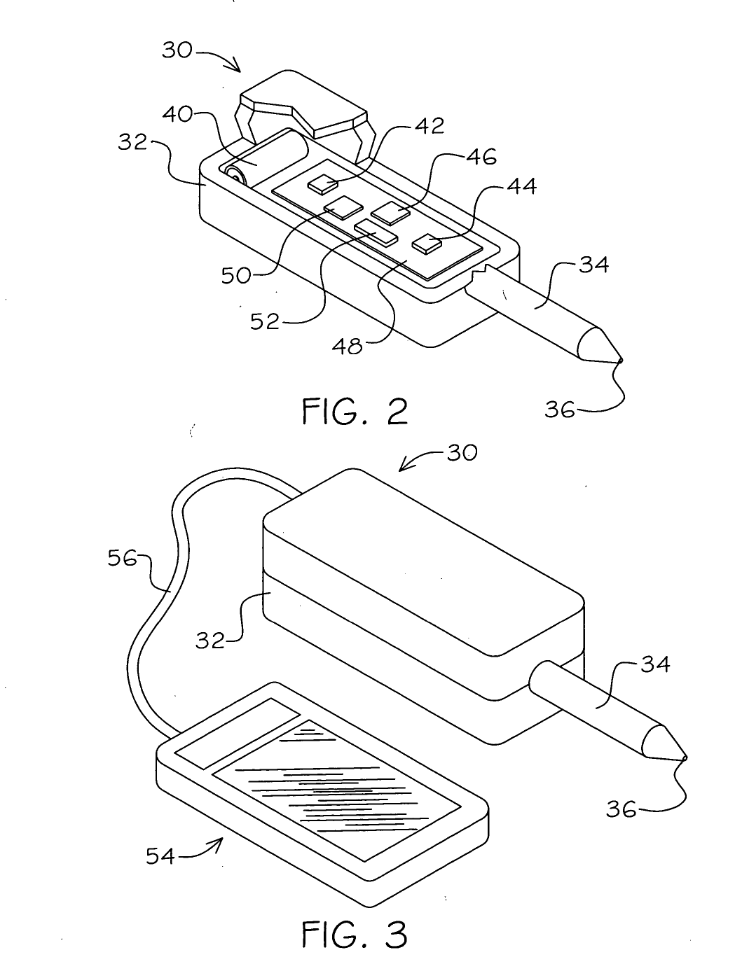

A cutaway showing the interior components of the position sensing device (30) can be viewed in FIG. 2. A board (48) supports the various electronic components. Attached to the board (48) are two solid state three axis accelerometers (42) and (44). There may be more than two accelerometers as part of the system. To further increase the accuracy, to an extent, a plurality of accelerometers may be utilized. These accelerometers can be either one axis, two axis, or three axis, and of any operational technology. In the present embodiment illustrated, the two solid state three axis accelerometers (42) and (44) are fixed a known distance apart, with a known orientation with respect to one another and the position pointer (36).

The acceleration data collected from each solid state three axis accelerometer (42) and (44) can be compared to derive a rotational relationship between the two. From this data, both the location of the position pointer (36) and the tilt of the rigid extension (34) can be calculated. Therefore, a position in space can be pointed to without regard to the tilt angle of the housing (32) and locator extension (34). For example, if the designated component position is above the head of the operator, the rigid extension (34) may be tilted upwards; and if the designated component position is below the waist of the operator, the rigid extension (34) may be tilted downwards.

Additionally attached to the board (48), are the logic circuit (46), the processor (50), and the data storage means (52). Acceleration input data developed by the two solid state three axis accelerometers (42) and (44) is received by the logic circuit (46). The output signal conditioned by the circuit logic (46) is transmitted to the processor (50). The processor (50), in turn, transmits at least one signal to the display (38), or an external computing means (54), or the data storage means (52). Additionally, data may be transmitted to the processor (50) from the data storage means (52), for the purpose of comparing the position sensing device's (30) location to a preprogrammed location in the data storage means (52). Proximity information may be viewed on the display (38) or communicated through an audible alarm.

A battery (40) is provided as a power source. Although not preferable, the position sensing device (30) can also be powered through an outlet. Alternatively, if the position sensing device (30) is connected to an external computing means (54), it may be powered through the cable (56), as seen in FIG. 3. The position sensing device (30) may be connected to the external computing means by USB cable, through the PCMCIA port, serial port, parallel port, or any available data transmission means that also can serve as a power source.

Looking again at FIG. 3, an alternate embodiment of the position sensing device (30) is shown. The rigid extension (34) is still protruding from the housing (32), with the position pointer (36) at the terminus of the rigid extension (34). The position sensing device (30) is connected to an external computing means (54) via cable (56). In this case, the integrated processor (50), data storage means (52), and display (38) are not necessary, and may be excluded. Although, the position sensing device (30) shown in FIG. 2 may also be connected to an external computing means (54). If the position sensing device (30) is exclusively connected to an external computing means (54), the output signal conditioned by the circuit logic (46) can be directly transmitted to the external computing means (54). Thereafter, the external computing means (54) can process and display the location and usage information. The position sensing device (30) in itself, in this embodiment, would smaller, simpler, and less expensive to produce. However, the benefits may be offset by the need for a PDA, laptop, or other computer.

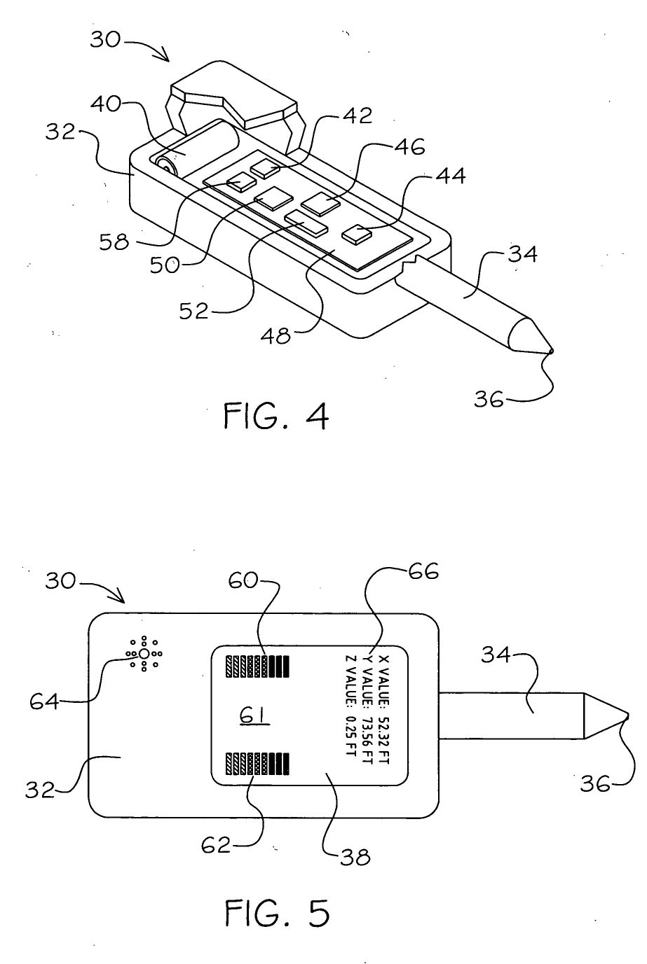

Yet another embodiment of the position sensing device (30) is seen in the cutaway of FIG. 4. A board (48) supports the various electronic components. Attached to the board (48) are two solid state three axis accelerometers (42) and (44) and a solid state three axis gyroscope (58). A plurality of solid state three axis gyroscopes (58) may be used in conjunction with a plurality of solid state three axis accelerometers (42) and (44). The translational path of travel is tracked by the solid state three axis accelerometers (42) and (44), while the tilt and rotation of the position sensing device (30) is tracked by the solid state three axis gyroscope (58). A logic circuit (46) or series of circuits responsive to the solid state three axis accelerometers (42) and (44) and the solid state three axis gyroscope (58) is included.

While the user is carrying the position sensing device (30) through a building, designating each designed component position point, the operational behavior of the user should be considered. For instance, if the user should drop the position sensing device (30) while in transit between two points or if the user were to carry the position sensing device (30) in a rough manner, the accelerometers and gyroscopes installed may be exposed to an acceleration and rotation that causes the them to operate in a range of reduced accuracy. In the situation where the position sensing device (30) is dropped, the accelerometer would experience an instantaneous acceleration that might exceed its ability to measure it accurately. Or, if the position sensing device (30) were to be carried in a rough manner, the accelerometer could operate for extended periods outside the ideal band of acceleration measurement, where accuracy is at its highest. For each given model of accelerometer, the degree to which the sensor is able to measure distance, derived from acceleration, is considered. For low ranges if acceleration, the accelerometer may have the highest distance measurement accuracy. For higher ranges if acceleration, the accelerometer may have the least distance measurement accuracy.

An upper limit of the acceleration range is chosen to define the region in which the accelerometer is operating at its highest accuracy. Beyond that limit, the accuracy may be reduced. Secondary and tertiary limits may be chosen, indicating stepwise the areas of further reduced accuracy. Each level of accuracy generally corresponds to a percentage error measurement over a given distance. It is most desirable to remain with the acceleration range of highest accuracy. Alternatively, a formula may be derived to correlate the given acceleration with an incremental degree of accuracy.

Looking more particularly at FIG. 5, the position sensing device (30) and its display (38) are shown. While in use, an accuracy meter interface (61) is visible to the user. In this case, the accuracy meter interface (61) is visible as a series of bars, stacking one on top of the other, changing from green to yellow and to red as the measurement uncertainty increases. Other forms of the accuracy meter interface (61) are possible, including a series of LED or similar lights, or any pictograph or text that is able to alert the user to current usage conditions. It is possible, for the accuracy meter interface (61), to be connected with an audible alarm through a speaker (64). Through the accuracy meter interface (61) and audible alarm, curative actions are encourage on the part of the operator to correct and prevent further behavior that could degrade the accuracy of the position sensing device's (30) measurement.

The instantaneous condition meter (60) viewable on the display (38) correlates to the instantaneous measure of acceleration. If the operator is within the highest range of accuracy, there will be few or no bars and they will remain green (or any representative color). As the operator approaches and exceeds the first limit of accuracy, the green bars will transition to yellow, indicating to the operator that the usage behavior should be altered. If the unit is dropped or likewise handled roughly, the bars will transition to red, indicating that the accuracy for that instance is not within the acceptable limits. All throughout the path of the position sensing device (30), the operator will be informed of the instantaneous accuracy by the instantaneous condition meter (60).

The cumulative condition meter (62) is used to represent the cumulative inaccuracy of the unit, as it progresses through a path. As the operator exposes the position sensing device (30) to repeated levels of acceleration approaching or exceeding the assigned limit, then the cumulative condition meter (62) will, again in a likewise tri-color bar fashion, indicate the level of accumulated inaccuracy. If the operator handles the position sensing device (30) with care, the cumulative condition meter (62) will remain in the green throughout the path. As the operator jostles the position sensing device (30), the green bars will progressively stack, representing the accumulation of error, until reaching the yellow area of stacked bars. At this point, the operator may decide to recalibrate the position sensing device (30) by zeroing it at a datum, or continue with greater care. If the operator continues to roughly handle the position sensing device (30), the bars will progressively stack to the red area. This would indicate that the position sensing device (30) can no longer guarantee the needed accuracy, and that is necessary to immediately recalibrate the position sensing device (30) at a datum.

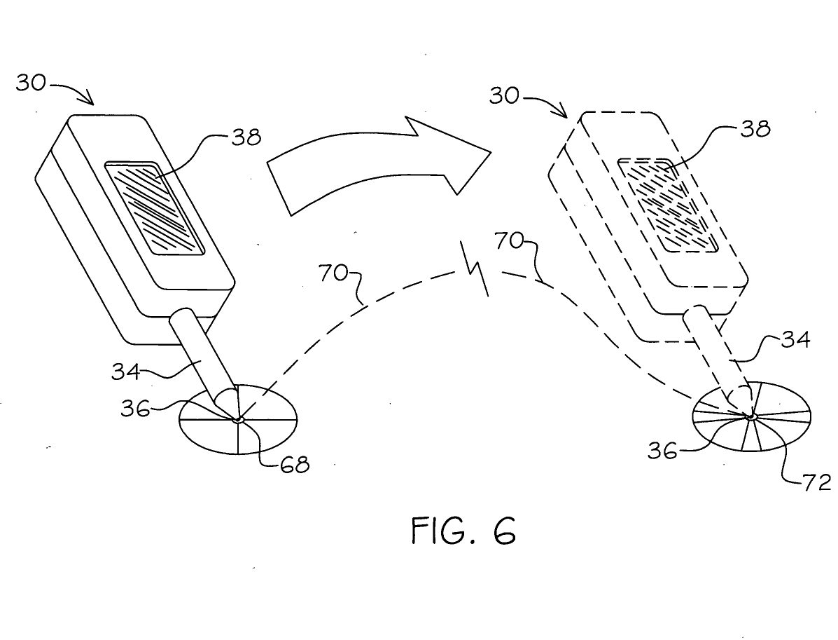

Looking at FIG. 6, the position sensing device (30) can be seen in operation. In the initial position, the position sensing device (30) is shown tilted down, with the rigid extension (34) extending towards the datum (68) and the position pointer (36) being placed directly on top of the datum (68). The datum (68) can be any mark, score, point landmark, or an object. At this point the operator inputs information into the position sensing device (30) indicating that an origin has been established at the datum (68) collocated with the position pointer (36). For this example, the origin has the coordinates of (0, 0, 0). The input can be achieved through a touch screen display (38), an external computing means (54) (if applicable), any viable input means.

From the datum (68), the operator can walk or move from the initial position, through a complex path (70), and finally to a located point (72). The located point (72) is illustrated for clarity; however, the located point (72) is more often a point on a wall, floor, ceiling, machinery, component, any object, or a point in space. As the operator approaches the located point (72) the location of the position sensing device (30) is displayed in Cartesian coordinates on the display (38). The operator can compare the displayed position with the targeted position, adjusting the movement of the position sensing device (30), shown in phantom, until the targeted position corresponds with the displayed position, and the position pointer (36) is located directly on the located point (72).

At this point, the operator can create a mark indicating the found position of a component. From the located point (72), the operator can proceed to the next targeted position, continuing this procedure until all of the targeted positions have been located and marked as a located point (72). The operator is also watch the cumulative condition meter (62) and the instantaneous condition meter (60) to determine if the accuracy of the position sensing device (30) is still in tact.

While the present invention has been described with regards to particular embodiments, it is recognized that additional variations of the present invention may be devised without departing from the inventive concept.

1. A position locating device for the construction or repair of a structure and components attached thereto comprising:
a housing;
a rigid extension protruding from said housing;
a position sensing means fixed to said housing;
a logic circuit responsive to said position sensing means;
wherein a terminus of said rigid extension indicates a position in a space;
wherein said terminus can be collocated with an origin and thereafter collocated with a point away from said origin, a vector being formed between said origin and said point, said vector being accurately measured by said position sensing means and said logic circuit combination.

2. The position locating device of claim 1 wherein said position sensing means is at least one accelerometer.

3. The position locating device of claim 1 wherein said position sensing means is at least one gyroscope and at least one accelerometer.

4. The position locating device of claim 1 wherein said rigid extension is generally converging to said terminus.

5. The position locating device of claim 1 wherein a logic circuit is responsive to said position sensing means; and a processor is responsive to said logic circuit.

6. The position locating device of claim 1 wherein said housing itself forms said rigid extension.

7. The position locating device of claim 1 wherein a processor is responsive to said logic circuit.

8. The processor of claim 7 wherein said processor is positioned within said housing.

9. The processor of claim 7 wherein said processor is positioned within an external computing means.

2. The position locating device of claim 1 wherein said terminus traces the outer geometry of an object, an internal position of said geometry being defined thereafter.

11. The position locating device of claim 1 wherein a definition of said vector formed between said origin and said point is displayed on a display means.

12. The display means of claim 11 wherein said display means is positioned within said housing.

13. The display means of claim 11 wherein said display means is positioned within an external computing means.

14. The position locating device of claim 1 wherein a definition of said vector formed between said origin and said point is recorded on a data storage means.

15. The data storage means of claim 14 wherein said data storage means is positioned within said housing.

16. The data storage means of claim 14 wherein said data storage means is positioned within an external computing means.

17. The position locating device of claim 1 wherein an instantaneous uncertainty of said position sensing means is communicated to an operator.

18. The instantaneous uncertainty of claim 17 wherein said instantaneous uncertainty is generally directly correlated to a numerical value of uncertainty

19. The instantaneous uncertainty of claim 17 wherein said instantaneous uncertainty is displayed graphically.

20. The position locating device of claim 1 wherein a cumulative uncertainty of said position sensing means is communicated to an operator.

21. The cumulative uncertainty of claim 20 wherein said cumulative uncertainty is generally directly correlated to a numerical value of uncertainty.

22. The cumulative uncertainty of claim 20 wherein said cumulative uncertainty is displayed graphically.

23. A position locating device for the construction or repair of a structure and components attached thereto comprising:
a housing;
a rigid extension protruding from said housing;
a position sensing means fixed to said housing;
a logic circuit responsive to said position sensing means;
a processor responsive to said logic circuit;
a data storage means;
a display means;
wherein a terminus of said rigid extension indicates a position;
wherein said terminus can be collocated with an origin and thereafter collocated with a point away from said origin, a vector being formed between said origin and said point, said vector being accurately measured by said position sensing means and said logic circuit combination; said vector recorded in said data storage means; said vector being displayed on said display means.

24. A method for locating a position relative to an origin, comprising the steps of:
providing a position locating device having a housing, said housing having a pointing means with a terminus, said position locating device having a position sensing means attached thereto, said position locating device being in data communication with a logic means, said position locating device being in data communication with a processing means, said position locating device being in data communication with a data storage means, said position locating device being in data communication with a display means;
collocating said terminus of said position locating device with said origin;
setting said origin as a datum, from which a measurement operation is originated;
removing said position locating device from said origin;
transporting said position locating device towards a point away from said origin;
collocating said terminus with said point away from said origin;
displaying on said display means a coordinate of said point relative to said origin.
